(19) United States
(12) Patent Application Publication
(10) Pub. No.: US 2026/0042375 A1
(43) Pub. Date: Feb. 12, 2026

(54) DIELECTRIC DETECTION FOR IMMERSION COOLED AUTOMOTIVE BATTERY SYSTEM

(71) Applicant: FORD GLOBAL TECHNOLOGIES, LLC, Dearborn, MI (US)

(72) Inventors: Thomas J. COUPAR, Ann Arbor, MI (US); Michael David BEENEY, Canton, MI (US); Philip Michael GONZALES, Dearborn, MI (US); Liam E. WEST, Ferndale, MI (US); Sangyeon KIM, Northville, MI (US)

(21) Appl. No.: 18/798,034

(22) Filed: Aug. 8, 2024

(51) Int. Cl. B60L 58/12; B60L 50/64; G01N 27/07; G01N 27/08; H01M 10/42; H01M 10/613; H01M 10/625; H01M 10/6568

(52) U.S. Cl. CPC B60L 58/12; B60L 50/64; G01N 27/07; G01N 27/08; H01M 10/425; H01M 10/613; H01M 10/625; H01M 10/6568; H01M 2010/4271; H01M 2220/20

(57) ABSTRACT

An automotive battery system for electrified vehicles is presented. The system includes a traction battery with arrays submerged in cooling fluid, and a pump circulating the fluid. The pump includes circuitry configured to detect current flow through the cooling fluid from the traction battery to the circuitry, indicating fluid contamination or isolation faults. This circuitry may be coupled with either high or low voltage pumps. A battery management system receives data from the circuitry, reports contamination levels, and may trigger responses including disabling arrays or adjusting charging rates.

### TECHNICAL FIELD

This disclosure relates to battery cooling systems for electrified vehicles.

### BACKGROUND

Immersion cooling systems can control temperature in high voltage battery systems, including battery cells and exposed high voltage components.

### SUMMARY

An automotive battery system includes a traction battery and a pump. The pump includes circuitry that detects current flow through the cooling fluid from the traction battery to the circuitry. The pump may be a high voltage pump powered by a traction battery or a low voltage pump powered by an auxiliary battery. The circuitry may include a resistive shunt for measuring the current flow. The circuitry may include a current sensor with low and high precision range capabilities. The circuitry may be coupled with a battery management system that receives data from the circuitry and reports fluid contamination based on the detected current flow. The battery management system may further categorize the detected current flow into an associated contamination level of the cooling fluid.

A vehicle power system includes a traction battery with one or more arrays submersed in a cooling fluid. The pump circulates cooling fluid over the one or more arrays using power from the traction battery, and includes circuitry that can be physically electrically connected with the one or more arrays via switches and can detect current flow through the cooling fluid. The pump may be a high voltage pump powered by the traction battery. Each array of the traction battery may include a battery pack supervisor module that measures current flow through the cooling fluid local to the array. The battery pack supervisor module may include a resistor or shunt attached to an array high voltage positive terminal or an array high voltage negative terminal to detect voltage changes associated with current flow through the cooling fluid. The circuitry may measure voltage from high voltage positive and negative terminals to chassis ground. In some configurations, battery pack supervisor modules may be coupled with a battery management system that correlates the detected current flow with vehicle diagnostic data to determine a contamination level of the cooling fluid. The battery management system may further determine if an isolation fault is located within the traction battery or externally based on the correlation. The circuitry may include multiple electrodes positioned at different locations within the cooling fluid.

An automotive system includes a housing, a traction battery and cooling fluid contained within the housing, and a pump. The pump is powered by the auxiliary battery to move the cooling fluid through the housing, and includes a resistor having a terminal electrically connected with the auxiliary battery and a terminal in contact with the cooling fluid. The pump may be a low voltage pump powered by the auxiliary battery. The pump may be coupled with a battery management system that receives data indicative of current flow through the cooling fluid and disables the traction battery based on the current flow. In some configurations, a battery management system may be coupled with the auxiliary battery, and adjust a charging rate of the traction battery based on the detected contamination level. The resistor may be part of a circuit that detects changes in dielectric properties of the cooling fluid, including at least one of electrical conductivity, dielectric constant, or impedance.

### BRIEF DESCRIPTION OF THE DRAWINGS

FIGS. 1 and 2 are schematic diagrams of electrified vehicle systems;

FIG. 3 is a block diagram of an electrified vehicle system; and

FIGS. 4 and 5 are schematic diagrams of immersion cooled battery systems.

### DETAILED DESCRIPTION

As required, detailed embodiments of the claimed subject matter are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments of the claimed subject matter.

The introduction of immersion cooling technology in high voltage (HV) battery systems for electric vehicles has allowed for new forms of thermal management and performance optimization. This approach, involving submerging battery cells and associated HV components in a specifically formulated dielectric fluid, may offer advantages over traditional air or liquid cooling methods. The benefits include increased heat transfer capabilities, a higher degree of uniform temperature distribution across the battery pack, and the potential for increased energy density. However, with immersion cooling technologies there may be difficulty in maintaining the integrity of the electrical isolation within the system.

The dielectric fluid is a component of immersion cooling systems. The dielectric fluid is a specifically engineered substance that should balance multiple properties. An example immersion coolant possesses high dielectric strength to maintain electrical isolation, low viscosity for efficient circulation, high thermal conductivity for effective heat dissipation, and chemical stability to prevent degradation under varying conditions. Choices for immersion cooling fluids include silicone oils, synthetic hydrocarbons, and specialized fluorinated liquids. Each type of fluid offers a profile of properties, and the selection process involves consideration of the specific requirements of the battery system, including operational temperature range, expected lifespan, and stability considerations.

The dielectric strength of the immersion cooling fluid plays a role in the stability and functionality of the HV battery system. The dielectric strength of the immersion cooling fluid allows the fluid to function as an effective insulator, preventing unintended electrical connections between HV components or between HV components and the vehicle chassis. However, the dielectric strength of the fluid may be compromised by various forms of contamination. Moisture ingress, even in minute quantities, can reduce the dielectric strength of the fluid. Particulate matter, which may enter the system from external sources or be generated internally through component wear, can create conductive pathways within the fluid. Over time, the fluid itself may undergo chemical degradation due to thermal stress or reactions with battery materials. In the event of cell impairment, battery electrolyte leakage into the cooling fluid can may also affect its insulating properties.

Methods for detecting isolation faults in HV battery systems focus on monitoring the electrical isolation between either the HV positive (HV+) or HV negative (HV−) and the chassis ground. These methods may be insufficient to fully address the specific challenges posed by immersion cooling systems. A consideration in immersion-cooled systems is the possibility of a dual fault scenario, where contamination of the cooling fluid may result in connections between both the HV+ and HV− to the chassis ground. This scenario requires consideration due to its implications for the battery and necessitates the development of improved detection and monitoring systems.

The present disclosure presents an approach for detecting and monitoring dielectric breakdown in immersion-cooled HV battery systems. It utilizes a pump-based sensing system to detect voltage drops or current flows between chassis ground and battery terminals, which may indicate fluid contamination or the onset of dielectric breakdown. This is achieved through the integration of high-precision measurement capabilities within the cooling system pump, capable of detecting minute voltage or current changes. The pump-based sensor is configured to measure electrical properties between the chassis ground and both the HV+ and HV− terminals, providing early indication of potential isolation issues or cooling fluid contamination.

The pump-based measurement system may be integrated into the Battery Management System (BMS), allowing for increased diagnostic ability. This analysis may correlate the current measurements with a wide array of existing diagnostic data, including cell voltage disparities, pack self-discharge rates, and temperature distribution anomalies. Algorithms may process this data to differentiate between normal operational currents and those indicative of dielectric breakdown, enabling the system to identify potential issues with high accuracy and minimal false positives.

In the presented approach, the implementation of isolation monitoring is centralized at the pump level, providing comprehensive pack-level checks. The pump-based sensing system is capable of performing isolation checks for the entire battery pack. This approach may allow for efficient fault detection, enabling the system to distinguish between internal battery pack issues and external isolation faults. The centralized nature of this monitoring system enhances overall reliability and provides data for predictive maintenance and fault diagnosis.

Passive measurement techniques configured to operate with minimal power consumption may also be incorporated. This allows for continuous fault monitoring, even when the vehicle is in a dormant state. The system may also perform rapid checks upon BMS or Battery Pack Sense Module (BPSM) wake-up, to allow for the detection of potential issues promptly without significantly affecting the vehicle's energy efficiency.

Responding to detected faults may be managed through a tiered response system. The severity of the detected issue may determine the appropriate action, ranging from the activation of diagnostic trouble codes or indicators for minor situations, to limiting charge/discharge rates or power output for more significant scenarios, and up to complete vehicle start inhibition and immediate protocol activation for other events. This approach balances user convenience with operational reliability to maintain vehicle functionality when possible.

The pump itself serves as the primary monitoring point within the fluid circulation system, enhancing the system's detection capabilities. By utilizing both the high voltage and low voltage sides of the pump/chiller system for redundant checks, the presented approach may provide a comprehensive view of fluid health throughout the entire circulation path.

The implementation of this detection system may involve specifically configured hardware and software components. The pump is equipped with high-precision voltage and/or current measurement capabilities, able to detect even the slightest anomalies in electrical properties between the chassis ground and battery terminals. The BMS and BPSM software may further incorporate machine learning algorithms that analyze current data in real-time, considering factors such as normal leakage currents, temperature-dependent variations in fluid conductivity, and transient currents during vehicle operation or charging.

The pump-based sensing system is equipped with dedicated processing capabilities for performing isolation checks, contributing to a robust and fault-tolerant system architecture. Data from the pump may be aggregated and analyzed by the central BMS, which may employ pattern recognition techniques to identify and differentiate between systemic issues and localized faults. This distributed yet integrated approach allows for comprehensive monitoring while enabling rapid and accurate fault diagnosis.

The passive measurement system may also incorporate ultra-low-power components, allowing for periodic checks even during extended periods of vehicle inactivity. This may allow for the detection of slow-developing faults that might otherwise go unnoticed between drive cycles, for increased reliability and performance.

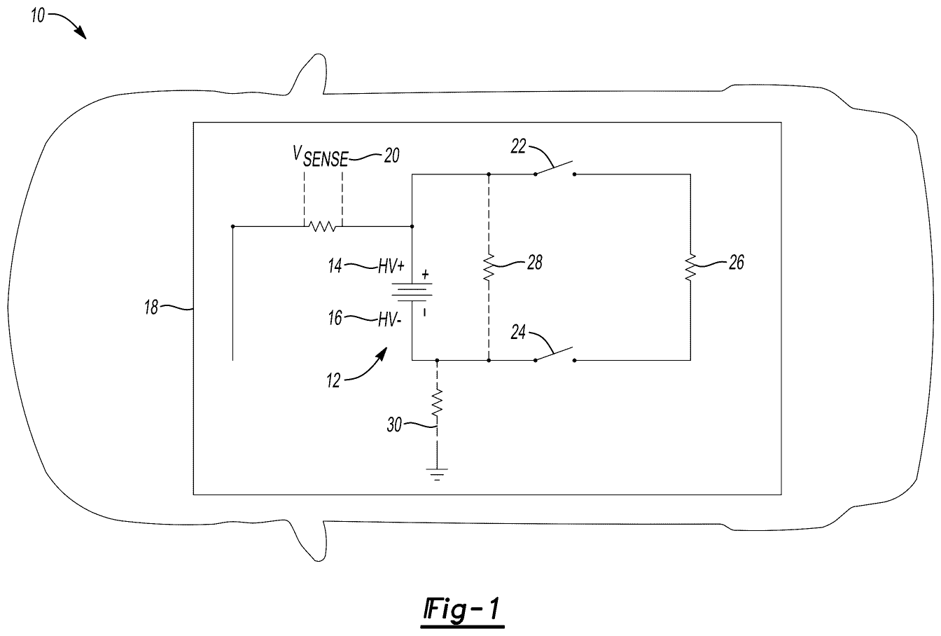

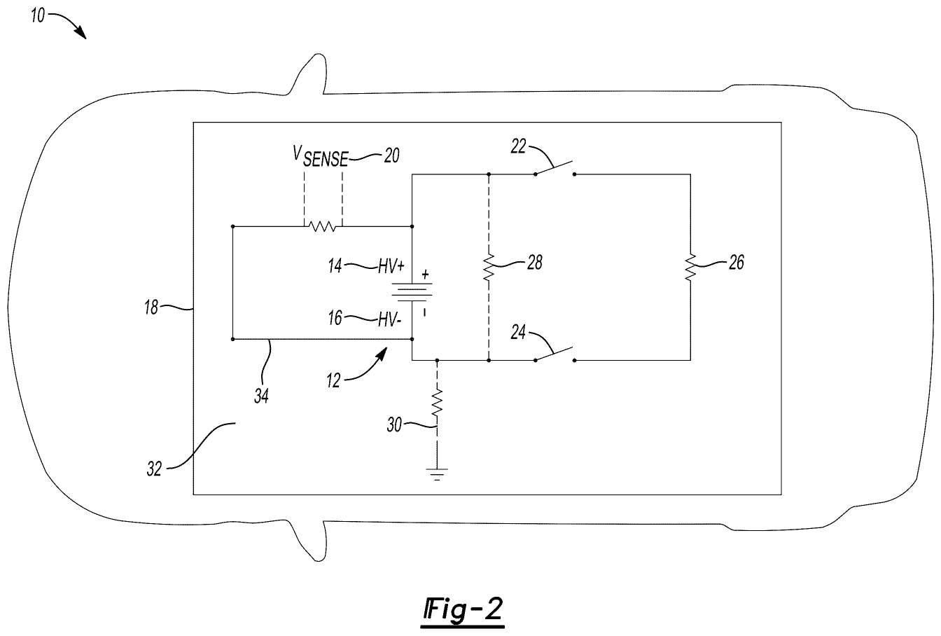

FIGS. 1 and 2 are schematic diagrams of a battery monitoring system 10 within an electrified vehicle system. A traction battery 12 has a HV positive terminal 14 and a HV negative terminal 16. The HV positive terminal 14 and the HV negative terminal 16 serve as the primary power conduits for an electric vehicle drivetrain. The battery 12 includes multiple array modules (not individually depicted in these figures) that are electrically interconnected to form a high-capacity energy storage system capable of powering the vehicle's electric motors and auxiliary systems.

The cooling fluid 18, which completely envelops the battery components, serves multiple functions. The cooling fluid 18 provides heat dissipation from individual battery cells, ensures a uniform temperature distribution across the entire battery 12, and acts as a dielectric medium, maintaining electrical isolation between high-voltage components. Under normal operating conditions, the cooling fluid 18 is configured to be non-conductive, thereby preserving the electrical integrity of the battery system.

The battery monitoring system 10 includes a pump-based sensing system 20. The pump-based sensing system 20 includes integrated measurement capabilities. The pump-based sensing system 20 is positioned in direct contact with the cooling fluid 18. A function of the pump-based sensing system 20 is to measure minute current flows that may develop due to changes in the electrical properties of the cooling fluid 18. The pump-based sensing system 20 may be capable of detecting extremely small voltage drops across itself, which serve as sensitive indicators of alterations in the fluid's electrical conductivity.

The battery monitoring system 10 incorporates a positive contactor 22 and a negative contactor 24. These are high-voltage switching devices that control the electrical connection between the battery 12 and a HV load 26. The contactors 22, 24 serve as disconnection measures, allowing for rapid electrical isolation of the battery 12 from the rest of a vehicle's HV system in the event of a detected fault or during maintenance procedures.

A high resistance component 28 represents the substantial electrical isolation maintained between the battery 12 and chassis ground 30. The high resistance component 28 preserves the electrical integrity of the vehicle, effectively preventing unintended current paths between the battery 12 and a vehicle's conductive body structure.

The HV load 26 represents the various HV vehicle components that draw power from the traction battery 12. This may include, but is not limited to, the electric drive motor, power electronics for motor control, and HV heaters or air conditioning compressors. A chassis ground 30 provides a common reference point for all vehicle electrical systems and ensures that any stray currents have a predetermined path to ground.

The physical contact the cooling fluid 18 makes with the HV positive terminal 14, HV negative terminal 16, and the chassis ground 30 allows the cooling fluid 18 to normalize the temperature of these components. Under normal circumstances, the dielectric properties of the cooling fluid 18 prevent any current flow between these points. However, if contaminants infiltrate the fluid and alter its electrical characteristics, potential current paths may form. The pump-based sensing system 20 is configured and positioned to detect these currents, which manifest as small but measurable voltage drops across the component.

The arrangement of the battery monitoring system 10 shown in FIGS. 1 and 2 allows for continuous, real-time monitoring of the cooling fluid's condition. Any increase in the electrical conductivity of the cooling fluid 18, which may be caused by the presence of conductive contaminants 32 or breakdown of the molecular structure of the cooling fluid 18, may result in a detectable current flow through the pump-based sensing system 20. This current flow produces a voltage drop across the pump-based sensing system 20, which may be precisely measured and analyzed by the battery monitoring system 10. As shown in FIG. 2, when the conductive contaminants 32 have reached a threshold level, a circuit 34 between the HV positive terminal 14 and HV negative terminal 16 is effectively formed.

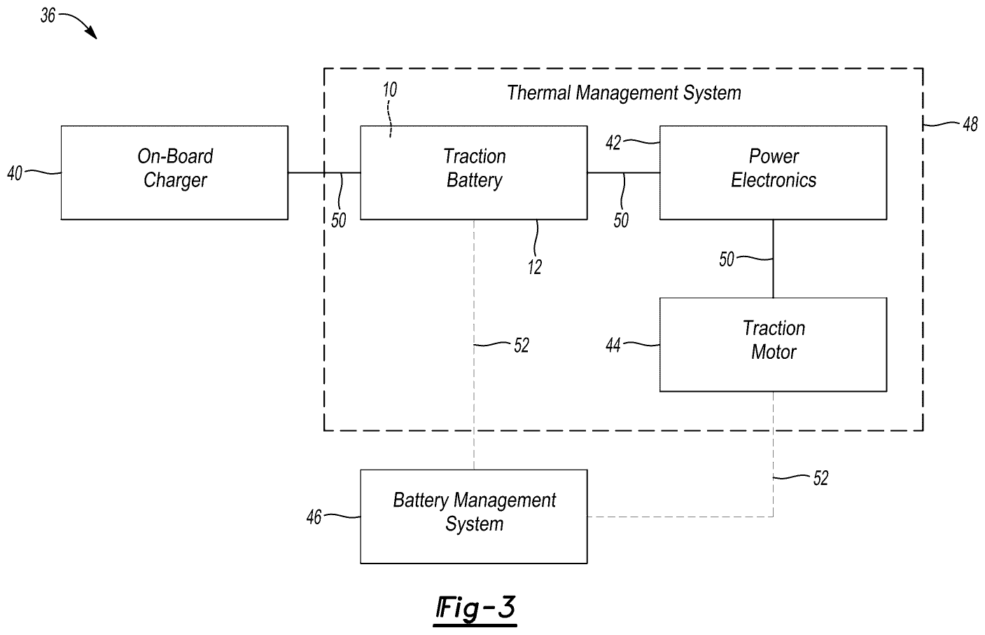

FIG. 3 is a block diagram of the overall electrified vehicle system 36, showing the relationships between major components and subsystems. The traction battery 12 serves as the primary energy storage unit for an electrified vehicle, providing the requisite power to drive the vehicle and operate its myriad electrical systems. The traction battery 12 includes array modules and the battery monitoring system 10 described in FIGS. 1 and 2. Coupled with the traction battery 12 is an on-board charger 40. The on-board charger 40 converts alternating current power from external charging stations into the direct current power required to charge the traction battery 12. The on-board charger 40 coupled with the traction battery 12 represents the high-voltage direct current charging circuit. This circuit may be designed to handle high power levels, often in the range of 50 to 350 kW, depending on a vehicle's fast-charging capabilities.

Further coupled with the traction battery 12 are power electronics 42. The power electronics 42 serve as the interface between the traction battery 12 and traction motor 44. The power electronics 42 may include inverter systems that convert the direct current power from the traction battery 12 into alternating current power required by the traction motor 44. Additionally, the power electronics 42 may manage bidirectional power flow, enabling regenerative braking by converting kinetic energy back into electrical energy to recharge the traction battery 12. The power electronics 42 may be coupled to the traction motor 44, which may include HV power circuits. The HV circuits may be configured to handle high currents, often exceeding 1000 amperes during peak load or regenerative braking events.

The traction motor 44 is the primary propulsion unit of the vehicle, responsible for converting electrical energy from the traction battery 12 into mechanical energy. The traction motor 44 may be of various types, such as permanent magnet synchronous motors or induction motors. The power electronics 42 coupled with the traction motor 44 represent the high-voltage alternating current power circuit that supplies the controlled, variable frequency and amplitude power needed to operate the traction motor 44 efficiently across a wide range of speeds and torques.

The BMS 46 is the control unit of an electric powertrain, monitoring and managing various aspects of the operation of the traction motor 44 and the traction battery 12. The BMS 46 is connected to the traction battery 12, power electronics 42, and traction motor 44. These connections represent the control and communication circuits that allow the battery management system to monitor and control these components. These circuits carry a multitude of signals, including battery cell voltage and temperature data, state of charge and state of health estimations, cooling fluid contamination sensor data, power demand signals to the motor controller, charging current and voltage control signals, and fault detection and mitigation commands.

Encompassing the traction battery 12, power electronics 42, and traction motor 44 is a thermal management system 48. This system is responsible for maintaining optimal operating temperatures for these components. It includes the battery monitoring system 10 for the traction battery 12 and may also include liquid or air-cooling systems for the power electronics 42 and traction motor 44. The thermal management system 48 may incorporate advanced features such as heat pumps for cabin climate control and battery preconditioning.

Power connections 50 between HV components carry the main power flows within the system, such as from the traction battery 12 to the traction motor 44 during high load events, or from the on-board charger 40 to the traction battery 12 during charging. These circuits are designed to handle voltages typically ranging from 400 to 800 volts in modern electric vehicles, with some systems pushing towards 1000 volts for improved efficiency.

Control and communication connections 52 allow the BMS 46 to monitor and control various aspects of the powertrain's operation. For example, the control and communication connections 52 to the traction motor 44 carry speed and torque control signals, while the control and communication connections 52 to the traction battery 12 include data from the thermal management system 48, individual cell voltages, temperatures, and other battery monitoring sensors. These communication lines may utilize automotive-grade protocols such as controller area network or other protocols like automotive Ethernet.

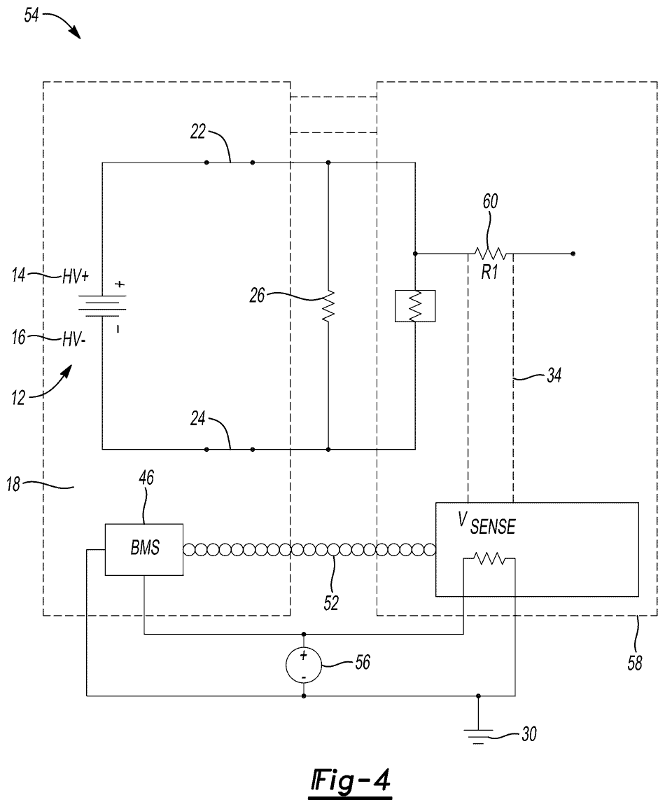

FIG. 4 is a schematic diagram of a battery monitoring system 54 with a HV pump configuration. The system includes the traction battery 12 within the battery monitoring system 54, having the HV positive terminal 14 and the HV negative terminal 16, with one or more arrays submersed in the cooling fluid 18. The battery monitoring system 54 includes an auxiliary battery 56 for powering auxiliary electronics such as the battery monitoring system 54. An HV pump 58 with associated circuitry 60 is powered by the traction battery 12 as one of HV loads 26 via the positive contactor switch 22 and the negative contactor switch 24 in a closed position. The HV pump 58 is configured to circulate cooling fluid 18 over the arrays of the traction battery 12. The circuitry 60 is physically electrically connected with the arrays via the positive contactor switch 22 and the negative contactor switch 24. The circuitry 60 may include a shunt which may be a resistor in physical contact with the cooling fluid 18, configured to detect current flow through the cooling fluid 18 from the traction battery 12 to the circuitry 60. Each array may include its own respective battery pack supervisor module to measure current flow through the cooling fluid 18 local to the array.

The circuitry 60 is configured to measure voltage from HV positive and negative terminals 14, 16 to chassis ground 30. The circuitry 60 may also include multiple electrodes positioned at different locations within the cooling fluid 18 for comprehensive monitoring. The BMS 46 is coupled with the battery pack supervisor modules. The BMS 46 receives data from the circuitry 60 and may report contamination of the cooling fluid 18 sufficient to form the closed circuit 34. The BMS 46 correlates the detected current flow with vehicle diagnostic data to determine a contamination level of the cooling fluid 18. The BMS 46 may also determine if an isolation fault is located within the traction battery 12 or externally based on this correlation. The BMS 46 is connected to the pump control unit via the communication connections 52.

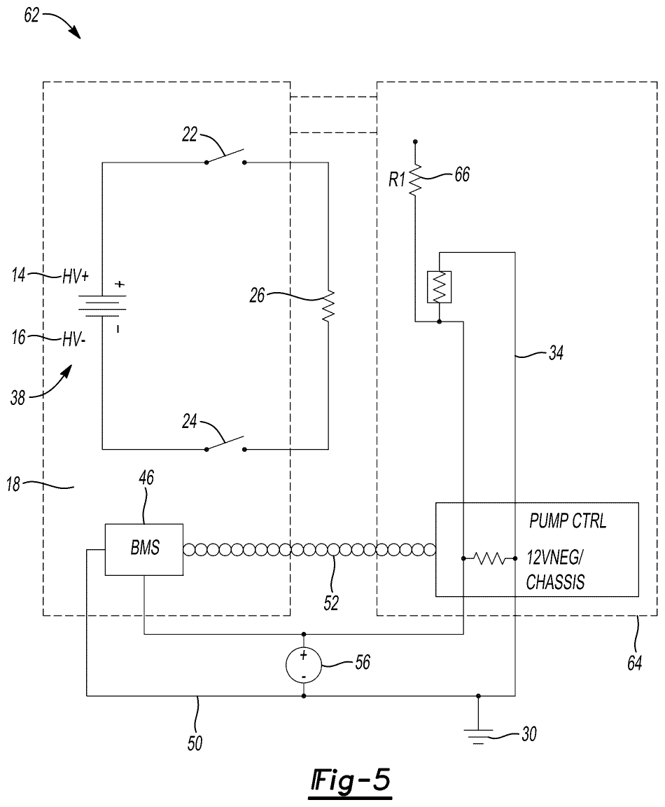

FIG. 5 is a schematic diagram of a battery monitoring system 62 with an LV pump configuration. In battery monitoring system 62 an LV pump 64 with associated circuitry 66 is configured to be powered by the auxiliary battery 56 through power connections 50 to move the cooling fluid 18 through the battery monitoring system 62. The circuitry 66 may include a shunt with a resistor having one terminal electrically connected with the auxiliary battery 56 and another terminal in contact with the cooling fluid 18. The circuitry 66 is configured to detect changes in dielectric properties of the cooling fluid 18, including electrical conductivity, dielectric constant, or impedance.

The BMS 46 is coupled with the LV pump 64 and its circuitry 66. It receives data indicative of the current flow through the cooling fluid 18 and can disable one or more arrays of the traction battery 12 if a detected contamination level reaches a threshold. The BMS 46 may also adjust the charging rate of the traction battery 12 based on the detected contamination level. As in the HV configuration, the BMS 46 is connected to the pump control unit via the communication connections 52. All components are referenced to the chassis ground 30. This LV pump configuration allows for monitoring and management of the condition of the cooling fluid 18 while utilizing a vehicle's LV electrical system.

While representative embodiments are described above, it is not intended that these embodiments describe all possible forms of the invention. The words used in the specification are words of description rather than limitation, and it is understood that various changes may be made without departing from the claimed subject matter. Additionally, the features of various implementing embodiments may be combined to form further embodiments within the scope of the claimed subject matter that are not explicitly described or illustrated.

What is claimed is:

1. An automotive battery system comprising:
a traction battery; and
a pump, configured to circulate cooling fluid through the traction battery, including circuitry configured to detect current flow through the cooling fluid from the traction battery to the circuitry.

2. The automotive battery system of claim 1 wherein the pump is a high voltage pump configured to be powered by the traction battery.

3. The automotive battery system of claim 1 further comprising an auxiliary battery, wherein the pump is a low voltage pump configured to be powered by the auxiliary battery.

4. The automotive battery system of claim 1 wherein the circuitry includes a resistive shunt for measuring the current flow.

5. The automotive battery system of claim 1 wherein the circuitry includes a current sensor with low and high precision range capabilities.

6. The automotive battery system of claim 1 further comprising a battery management system configured to receive data from the circuitry and report fluid contamination based on the current flow.

7. The automotive battery system of claim 6 wherein the battery management system is further configured to categorize the current flow into an associated contamination level of the cooling fluid.

8. A vehicle power system comprising:
a traction battery including one or more arrays submersed in a cooling fluid; and
a pump, configured to circulate cooling fluid over the one or more arrays using power from the traction battery, including circuitry configured to be physically electrically connected with the one or more arrays via switches and to detect current flow through the cooling fluid.

9. The vehicle power system of claim 8 wherein each of the arrays includes a battery pack supervisor module configured to measure the current flow through the cooling fluid local to the array.

10. The vehicle power system of claim 9 wherein each of the battery pack supervisor modules includes a shunt attached to an array high voltage terminal to detect voltage changes associated with the current flow through the cooling fluid.

11. The vehicle power system of claim 8 wherein the circuitry is further configured to measure voltage from positive and negative terminals to chassis ground.

12. The vehicle power system of claim 8 further comprising battery pack supervisor modules, and a battery management system coupled with the battery pack supervisor modules and configured to correlate the current flow with diagnostic data.

13. The vehicle power system of claim 8 wherein the circuitry includes multiple electrodes positioned at different locations within the cooling fluid.

14. An automotive system comprising:
a housing;
a traction battery and cooling fluid contained within the housing;
an auxiliary battery; and
a pump, configured to be powered by the auxiliary battery to move the cooling fluid through the housing, including a resistor having a terminal electrically connected with the auxiliary battery and a terminal in contact with the cooling fluid.

15. The automotive system of claim 14 further comprising a battery management system configured to receive data indicative of current flow through the cooling fluid and to disable the traction battery based on the data.

16. The automotive system of claim 15 further comprising a battery management system configured to adjust a charging rate of the traction battery based on the data.

17. The automotive system of claim 14 further comprising a circuit that includes the resistor and is configured to detect changes in dielectric properties of the cooling fluid including at least one of electrical conductivity, dielectric constant, or impedance.
